(19) United States
(12) Patent Application Publication
(10) Pub. No.: US 2021/0018317 A1
(43) Pub. Date: Jan. 21, 2021

(54) ROAD SURFACE WATER DEPTH CALCULATION DEVICE

(71) Applicant: AISIN SEIKI KABUSHIKI KAISHA, Kariya-shi (JP)

(72) Inventors: Hiroshi NOMA, Kariya-shi (JP); Yuhei MORI, Kariya-shi (JP); Eiji NIWA, Kariya-shi (JP)

(73) Assignee: AISIN SEIKI KABUSHIKI KAISHA, Kariya-shi (JP)

(21) Appl. No.: 16/841,729

(22) Filed: Apr. 7, 2020

(30) Foreign Application Priority Data
Jul. 19, 2019 (JP) 2019-133522

(51) Int. Cl. G01C 13/00; B60W 40/06

(52) U.S. Cl. CPC G01C 13/008; B60W 40/06

(57) ABSTRACT

A road surface water depth calculation device includes: an acquisition unit configured to acquire flooding locations at which a vehicle travels and water depth candidates of the flooding locations; an extraction unit configured to extract a plurality of continuous flooding locations from the acquired flooding locations; an altitude acquisition unit configured to acquire altitudes of the extracted flooding locations; an estimation unit configured to calculate a sum of the water depth candidate and the altitude, acquired by the altitude acquisition unit, of each of the extracted flooding locations, and estimate the sum as a water surface altitude which is an altitude of a water surface of each of the extracted flooding locations; and a calculation unit configured to calculate a water depth of the extracted flooding location based on the water surface altitude and the altitude, acquired by the altitude acquisition unit, of each of the extracted flooding locations.

### CROSS REFERENCE TO RELATED APPLICATIONS

This application is based on and claims priority under 35 U.S.C. §119 to Japanese Patent Application 2019-133522, filed on Jul. 19, 2019, the entire contents of which are incorporated herein by reference.

### TECHNICAL FIELD

This disclosure relates to a road surface water depth calculation device.

### BACKGROUND DISCUSSION

JP A-2018-18424 (Reference 1) discloses a technique in which a boundary position, on a road surface, between a flooding location which is flooded and a non-flooding location other than the flooding location is detected based on a captured image captured by an imaging unit mounted on a vehicle, and a water depth at the flooding location is calculated based on a detection result of the boundary position and an altitude of the boundary position.

However, in the above-mentioned technique, when a wave is generated at the flooding location, or water splashes from the flooding location occurs due to an approach of the vehicle to the flooding location, the boundary position between the flooding location and the non-flooding location is changed. Therefore, accuracy of calculating the water depth at the flooding location may be reduced.

Thus, a need exists for a road surface water depth calculation device which is not susceptible to the drawback mentioned above.

### SUMMARY

A road surface water depth calculation device according to an aspect of this disclosure includes, as an example, an acquisition unit configured to acquire flooding locations at which a vehicle travels and water depth candidates of the flooding locations; an extraction unit configured to extract a plurality of continuous flooding locations from the acquired flooding locations; an altitude acquisition unit configured to acquire altitudes of the extracted flooding locations; an estimation unit configured to calculate a sum of the water depth candidate and the altitude, acquired by the altitude acquisition unit, of each of the extracted flooding locations, and estimate the sum as a water surface altitude which is an altitude of a water surface of each of the extracted flooding locations; and a calculation unit configured to calculate a water depth of the extracted flooding location based on the water surface altitude and the altitude, acquired by the altitude acquisition unit, of each of the extracted flooding locations.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exemplary schematic configuration diagram illustrating a configuration of a road surface flooding determination system which is applied to a road surface water depth calculation device according to an embodiment;

FIG. 2 is a flowchart illustrating an example of a flow of a process for transmitting flooding data by a vehicle according to the present embodiment; and

FIG. 3 is a flowchart illustrating an example of a flow of a process for calculating a water depth at a flooding location by a road information providing device according to the present embodiment.

### DETAILED DESCRIPTION

Hereinafter, an embodiment will be disclosed. A configuration of the embodiment described below, and operations, results, and effects provided by the configuration are examples. This disclosure can be implemented by configurations other than those disclosed in the following embodiment, and can obtain at least one of various effects based on the basic configuration and derivative effects.

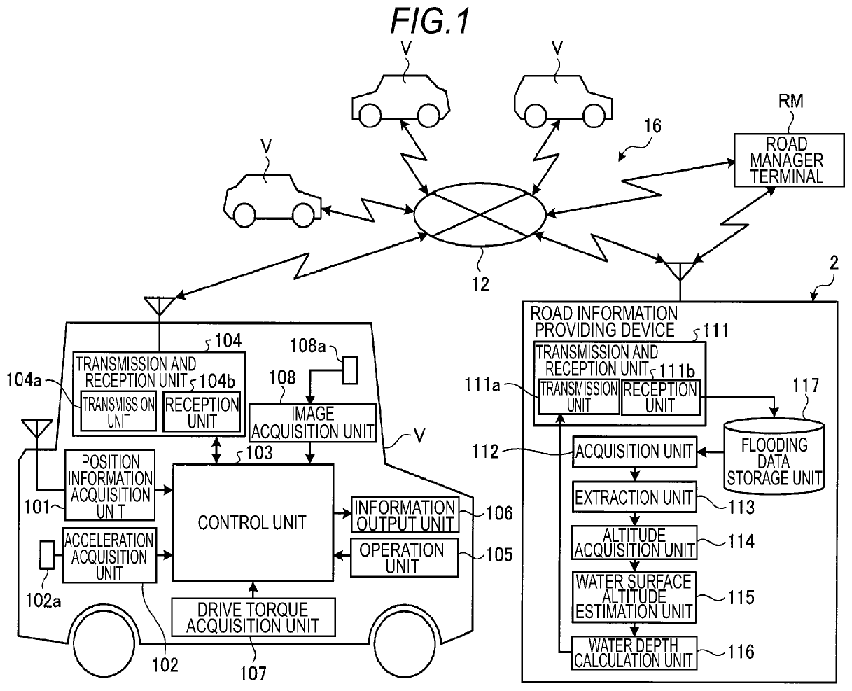

FIG. 1 is an exemplary schematic configuration diagram illustrating a configuration of a road surface flooding determination system which is applied to a road surface water depth calculation device according to the present embodiment.

Firstly, an example of the configuration of the road surface flooding determination system according to the present embodiment will be described with reference to FIG. 1.

As illustrated in FIG. 1, the road surface flooding determination system according to the present embodiment includes a plurality of vehicles V, a road information providing device 2, and a road manager terminal RM. The plurality of vehicles V, the road information providing device 2 and the road manager terminal RM are connected via a network 12.

As illustrated in FIG. 1, the vehicle V includes an acceleration sensor 102a, an operation unit 105, an information output unit 106, and an imaging unit 108a.

The acceleration sensor 102a detects an effective acceleration applied to the vehicle V during traveling (hereinafter, referred to as an actual acceleration). In the present embodiment, the acceleration sensor 102a detects the actual acceleration applied to the vehicle V in a front-rear direction. As the acceleration sensor 102a, for example, an acceleration sensor used for detecting attitude of the vehicle V, detecting a side slip, or the like, or an acceleration sensor that detects an impact and is used for an airbag system or the like maybe used.

The operation unit 105 receives various operations performed on the vehicle V by an occupant of the vehicle V. For example, the operation unit 105 receives an acquisition request for acquiring road information such as road surface flooding information generated by the road information providing device 2. Here, the road surface flooding information is information related to flooding of a road surface, such as a flooding location where flooding occurs on a road on which the vehicle V travels, a water depth of the flooding location, or the like.

The information output unit 106 is a display unit that displays the road information received from the road information providing device 2 in a manner visually observable for the occupant of the vehicle V, or a sound output unit that outputs the road information by voice or the like in response to the acquisition request received by the operation unit 105.

The imaging unit 108a is an imaging unit that is provided such that an image around the vehicle V can be captured. The imaging unit 108a is a digital camera having a built-in imaging element such as a charge coupled device (CCD) or a CMOS image sensor (CIS). The imaging unit 108a outputs a captured image captured at a preset frame rate.

Further, the vehicle V has hardware such as a processor and a memory, and the processor reads and executes a program stored in the memory to implement various functional modules. As illustrated in FIG. 1, the vehicle V includes, as the functional modules, a position information acquisition unit 101, an acceleration acquisition unit 102, a control unit 103, a transmission and reception unit 104, a drive torque acquisition unit 107, an image acquisition unit 108, and the like.

In the present embodiment, the position information acquisition unit 101, the acceleration acquisition unit 102, the control unit 103, the transmission and reception unit 104, the drive torque acquisition unit 107, and the image acquisition unit 108 are implemented by the processor reading and executing the program stored in the memory, but the present embodiment is not limited to this.

For example, the position information acquisition unit 101, the acceleration acquisition unit 102, the control unit 103, the transmission and reception unit 104, the drive torque acquisition unit 107 and the image acquisition unit 108 may be implemented by independent hardware. Further, the position information acquisition unit 101, the acceleration acquisition unit 102, the control unit 103, the transmission and reception unit 104, the drive torque acquisition unit 107 and the image acquisition unit 108 are examples, and as long as same functions can be implemented, each of the functional modules may be integrated or subdivided.

The position information acquisition unit 101 acquires position information indicating a traveling position (current position) of the vehicle V. The position information acquisition unit 101 acquires the position information of the vehicle V by using, for example, a global positioning system (GPS) or the like. Alternatively, the position information acquisition unit 101 may acquire the position information of the vehicle V acquired by another system such as a navigation system mounted on the vehicle V.

The acceleration acquisition unit 102 acquires the actual acceleration applied to the vehicle V. In the present embodiment, the acceleration acquisition unit 102 acquires the actual acceleration applied to the vehicle V in the front-rear direction by detection of, for example, the acceleration sensor 102a that is already provided in the vehicle V.

The drive torque acquisition unit 107 acquires drive torque of the vehicle V. In the present embodiment, the drive torque acquisition unit 107 acquires the drive torque applied to wheels of the vehicle V from a drive unit (for example, an electric motor or an engine) of the vehicle V.

The image acquisition unit 108 acquires, from the imaging unit 108a, a captured image obtained by capturing an image around the vehicle V.

The control unit 103 is an example of a control unit that controls the entire vehicle V.

Specifically, the control unit 103 controls a transmission unit 104a, which will be described later, to transmit various types of information to an external device (for example, the road information providing device 2, or the road manager terminal RM).

In the present embodiment, the control unit 103 generates flooding data, and controls the transmission unit 104a described later to transmit the generated flooding data to the road information providing device 2.

Here, the flooding data is data related to the flooding location where the vehicle V traveled. In the present embodiment, the flooding data is data indicating a traveling position (including the flooding location) of the vehicle V indicated by the position information acquired by the position information acquisition unit 101, a candidate for a water depth at a flooding location (hereafter referred to as a water depth candidate), a current time measured by a time measuring unit (not shown) (for example, RTC: real time clock), and the like.

Further, in the present embodiment, the control unit 103 controls the transmission unit 104a, which will be described later, to transmit the acquisition request of the road information received by the operation unit 105 to the road information providing device 2.

Further, the control unit 103 controls the reception unit 104b, which will be described later, to receive various information from the external device (for example, the road information providing device 2 or the road manager terminal RM). In the present embodiment, the control unit 103 controls the reception unit 104b, which will be described later, to receive the road information from the road information providing device 2.

Further, the control unit 103 outputs the road information such as the road surface flooding information received from the road information providing device 2 to the information output unit 106.

Further, the control unit 103 controls the vehicle V based on various operations received by the operation unit 105.

Further, the control unit 103 determines whether or not the traveling position of the vehicle V is the flooding location based on at least one of the captured image acquired by the image acquisition unit 108 and a travel resistance of the vehicle V.

Here, the travel resistance of the vehicle V is a force other than a force generated by the drive torque among forces applied to the vehicle V. For example, the travel resistance of the vehicle V is the force applied to the vehicle V due to a gradient of the road surface on which the vehicle V travels, or wind blowing on the road surface on which the vehicle V travels, or decrease in air pressure of tires of the vehicle V, or flooding of the road surface.

In the present embodiment, the control unit 103 calculates the travel resistance of the vehicle V based on the drive torque acquired by the drive torque acquisition unit 107 and the actual acceleration acquired by the acceleration acquisition unit 102. Then, the control unit 103 determines that the traveling position of the vehicle V is the flooding location when the calculated travel resistance of the vehicle V is equal to or greater than a predetermined threshold value. Here, the predetermined threshold value is a threshold value of the travel resistance that is preset and at which the traveling position of the vehicle V is determined as the flooding location.

Here, it is preferable that the captured image is a captured image obtained by capturing an image around the vehicle V by the imaging unit 108a provided on a side surface of the vehicle V. In the present embodiment, the control unit 103 performs image processing or the like on the captured image, and determines whether or not a state in which a vehicle body of the vehicle V is immersed in water is included in the captured image. Then, the control unit 103 determines that the traveling position of the vehicle V is the flooding location when it is determined that the state in which the vehicle body of the vehicle V is immersed in the water is included in the captured image.

In the present embodiment, the control unit 103 determines that the traveling position of the vehicle V is the flooding location when it is determined that the traveling position of the vehicle V is the flooding location based on the captured image or the travel resistance of the vehicle V, but the disclosure is not limited to this, and the control unit 103 may determine that the traveling position of the vehicle V is the flooding location when it is determined that the traveling position of the vehicle V is the flooding location based on both of the captured image and the travel resistance of the vehicle V.

Further, when it is determined that the traveling position of the vehicle V is the flooding location, the control unit 103 estimates a water depth candidate which is a candidate for the water depth at the flooding location based on the captured image which is captured by the imaging unit 108a while the vehicle V is traveling at the flooding location.

In the present embodiment, the control unit 103 determines which part of the vehicle body of the vehicle V is immersed in the water based on the captured image, and estimates the water depth candidate at the flooding location based on a result of the determination. For example, it is assumed that the vehicle V stores a water depth database in advance in which a part of the vehicle body of the vehicle V is associated with a water depth. Then, based on the captured image, the control unit 103 specifies a part of the vehicle body of vehicle V that is immersed in the water. Next, the control unit 103 estimates a water depth associated with the specified part in the water depth database as the water depth candidate at the flooding location.

In the present embodiment, the control unit 103 estimates the water depth candidate at the flooding location by using the captured image, but the disclosure is not limited this, and the water depth candidate at the flooding location may also be estimated based on the travel resistance of the vehicle V. For example, it is assumed that the vehicle V stores a travel resistance database in advance. Here, the travel resistance database is a database in which a travel resistance applied to the vehicle V is associated with a water depth. In this case, the control unit 103 estimates, in the travel resistance database, the water depth associated with the travel resistance generated in the vehicle V during traveling at the flooding location as the water depth candidate at the flooding location. It is assumed that the water depth associated with the travel resistance in the travel resistance database increases as the travel resistance increases.

The transmission and reception unit 104 is a communication unit that manages communication with the external device such as the road information providing device 2 and the road manager terminal RM that are connected via the network 12. In the present embodiment, the transmission and reception unit 104 includes the transmission unit 104a and the reception unit 104b.

The transmission unit 104a transmits the flooding data generated by the control unit 103 to the road information providing device 2 via the network 12. Further, the transmission unit 104a transmits the acquisition request received by the operation unit 105 to the road information providing device 2 via the network 12.

The reception unit 104b receives, via the network 12, the road information such as the road surface flooding information transmitted from the road information providing device 2.

In the present embodiment, the determination of whether or not the traveling position of the vehicle V is the flooding location, and the estimation of the water depth candidate at the flooding location are performed in the vehicle V, but the determination of whether or not the traveling position of the vehicle V is the flooding location, and the estimation of the water depth candidate at the flooding location may also be performed in the external device by transmitting the captured image captured by the imaging unit 108a, the drive torque acquired by the drive torque acquisition unit 107, and traveling data such as the actual acceleration acquired by the acceleration acquisition unit 102 to the external device (for example, the road information providing device 2 or road manager terminal RM).

Next, an example of a functional configuration of the road information providing device 2 that is applied to the road surface flooding determination device according to the present embodiment will be described with reference to FIG. 1.

The road information providing device 2 is provided in, for example, a base station capable of wireless communication with the vehicle V, an edge, a cloud, or the like. The road information providing device 2 includes a personal computer having the hardware such as the processor and the memory.

Specifically, the road information providing device 2 includes a transmission and reception unit 111, an acquisition unit 112, an extraction unit 113, an altitude acquisition unit 114, a water surface altitude estimation unit 115, a water depth calculation unit 116, and a flooding data storage unit 117. In the present embodiment, the processor reads and executes a program stored in the memory, such that the road information providing device 2 implements various functional modules of the transmission and reception unit 111, the acquisition unit 112, the extraction unit 113, the altitude acquisition unit 114, the water surface altitude estimation unit 115, the water depth calculation unit 116, and the like.

In the present embodiment, the various functional modules such as the transmission and reception unit 111, the acquisition unit 112, the extraction unit 113, the altitude acquisition unit 114, the water surface altitude estimation unit 115, and the water depth calculation unit 116 are implemented by the processor reading and executing the program stored in the memory, but the disclosure is not limited to this. For example, the various functional modules such as the transmission and reception unit 111, the acquisition unit 112, the extraction unit 113, the altitude acquisition unit 114, the water surface altitude estimation unit 115, and the water depth calculation unit 116 may be implemented by independent hardware. Further, the various functional modules such as the transmission and reception unit 111, the acquisition unit 112, the extraction unit 113, the altitude acquisition unit 114, the water surface altitude estimation unit 115 and the water depth calculation unit 116 are examples, and as long as same functions can be implemented, each of the functional modules may be integrated or subdivided.

The flooding data storage unit 117 is a storage unit that is implemented by the memory included in the road information providing device 2 and stores flooding data received by a reception unit 111b described below.

The transmission and reception unit 111 is a communication unit that manages communication with the external device such as the vehicle V and the road manager terminal RM that are connected via the network 12. In the present embodiment, the transmission and reception unit 111 includes a transmission unit 111a and the reception unit 111b.

The transmission unit 111a transmits the road surface flooding information indicating a calculation result of the water depth at a flooding position to the vehicle V or the road manager terminal RM via the network 12.

The reception unit 111b receives the flooding data from the vehicle V via the network 12. Then, the reception unit 111b writes the received flooding data into the flooding data storage unit 117.

The acquisition unit 112 acquires a flooding location where the vehicle V travels and a water depth candidate at the flooding location. In the present embodiment, the acquisition unit 112 acquires the flooding location and the water depth candidate of the flooding location by reading the flooding data from the flooding data storage unit 117.

The extraction unit 113 extracts a plurality of continuous flooding locations from the flooding locations acquired by the acquisition unit 112. In the present embodiment, the road information providing device 2 stores a terrain information database in advance. Here, the terrain information database is a database in which a position of a road (road surface) is associated with terrain information of the position (for example, an altitude or a gradient of the position of the road).

Therefore, in the present embodiment, the extraction unit 113 extract a plurality of continuous flooding locations based on the terrain information associated with the flooding location indicated by the flooding data (for example, an altitude or a gradient of the flooding position) in the terrain information database.

The altitude acquisition unit 114 acquires an altitude of the extracted flooding locations. In the present embodiment, the altitude acquisition unit 114 selects a flooding location as a reference (hereinafter, referred to as a reference flooding location) from the plurality of continuous flooding locations. Next, the altitude acquisition unit 114 acquires an altitude indicated by the terrain information associated with the reference flooding location in the terrain information database as an altitude of the extracted flooding locations.

The water surface altitude estimation unit 115 calculates a sum of the respective water depth candidates of the plurality of flooding locations extracted by the extraction unit 113 and the respective altitudes acquired by the altitude acquisition unit 114, and estimates the sum as an altitude of a water surface (hereinafter referred to as a water surface altitude) at each of the plurality of the extracted flooding locations.

The water depth calculation unit 116 calculates a water depth of the reference flooding location based on the water surface altitude of each of the plurality of the extracted flooding locations and the altitude acquired by the altitude acquisition unit 114. Therefore, even if the water depth candidate calculated in the vehicle V that travels at the reference flooding location is influenced by waves or water splashes at the flooding location that is continuous with the reference flooding location, it is possible to calculate the water depth with the influence of the waves or the water splashes at the flooding location being reduced. As a result, accuracy of calculating the water depth at the reference flooding location can be improved.

Specifically, the water depth calculation unit 116 calculates, as the water depth of the reference flooding location, a value which is obtained by subtracting the altitude acquired by the altitude acquisition unit 114 from an average of water surface altitudes of the plurality of extracted flooding locations, a mode value among the water surface altitudes of the plurality of extracted flooding locations, or a median value among the water surface altitudes of the plurality of extracted flooding locations.

Further, the water depth calculation unit 116 calculates a maximum water depth among the water depths of a flooding region including the plurality of continuous flooding locations and a flooding location thereof, based on the calculation result of the water depth of the reference flooding location and the terrain information of the reference flooding location. Therefore, even if the water depth candidate calculated in the vehicle V that travels at the reference flooding location is influenced by waves or water splashes at the flooding locations that are continuous with the reference flooding location, it is possible to calculate the maximum water depth with the influence of the waves or the water splashes at the flooding location being reduced. As a result, accuracy of calculating the maximum water depth at the flooding location can be improved.

In the present embodiment, the water depth calculation unit 116 specifies a flooding location having a lowest altitude among flooding positions that are continuous with the reference flooding location, based on the terrain information of the reference flooding location. Next, the water depth calculation unit 116 calculates a difference between the altitude of the specified flooding location and the altitude of the reference flooding location, and adds the difference to the water depth of the reference flooding location so as to obtain the maximum water depth at the flooding region including the plurality of extracted flooding locations.

In the present embodiment, an example is described in which the road surface water depth calculation device is provided in an external device (for example, the road information providing device 2) of the vehicle V, but the road surface flooding determination device may also be provided in the vehicle V as long as the vehicle V can acquire flooding data of another vehicle V. Further, as long as the road manager terminal RM can acquire the flooding data of the plurality of vehicles V, the road surface flooding determination device may also be provided in the road manager terminal RM.

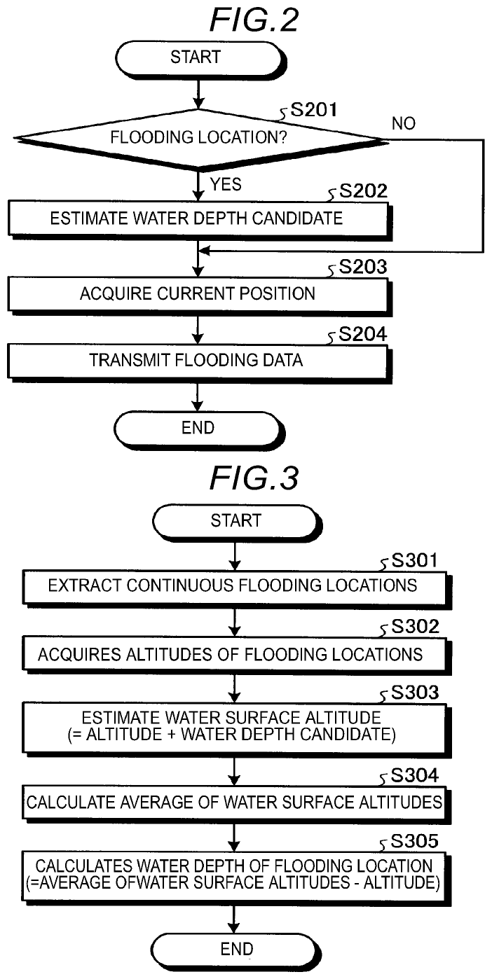

FIG. 2 is a flowchart illustrating an example of a flow of a process for transmitting the flooding data by the vehicle according to the present embodiment.

Next, the example of the flow of the process for transmitting the flooding data by the vehicle V according to the present embodiment will be described with reference to FIG. 2.

The control unit 103 determines whether or not the traveling position of the vehicle V is the flooding location based on the captured image acquired by the image acquisition unit 108 or the travel resistance of the vehicle V (step S201).

When it is determined that the traveling position of the vehicle V is the flooding location control unit (step S201: Yes), the control unit 103 estimates a water depth candidate at the flooding location based on the captured image captured by the imaging unit 108a while the vehicle V is traveling at the flooding location (step S202).

When it is determined that the traveling position of the vehicle V is not the flooding location (step S201: No), the control unit 103 acquires a current position of the vehicle V indicated by the position information acquired by the position information acquiring unit 101 (step S203), and generates the flooding data indicating the current position of the vehicle V. Then, the control unit 103 controls the transmission unit 104a to transmit the generated flooding data to the road information providing device 2 via the network 12 (step S204).

On the other hand, when it is determined that the traveling position of the vehicle V is the flooding location (step S201: Yes), and the water depth candidate of the flooding location is estimated (step S202), the control unit 103 acquires the current position of the vehicle V indicated by the position information acquired by the position information acquisition unit 101 as the flooding location (step S203). Then, the control unit 103 generates the flooding data indicating the obtained flooding location and the water depth candidate at the flooding location estimated by the estimation unit 110. Then, the control unit 103 transmits the generated flooding data to the road information providing device 2 via the network 12 (step S204).

FIG. 3 is a flowchart illustrating an example of a flow of a process for calculating a water depth of a flooding location by the road information providing device according to the present embodiment.

Next, the example of the flow of the process for calculating the water depth of the flooding location by the road information providing device 2 according to the present embodiment will be described with reference to FIG. 3.

First, the extraction unit 113 extracts a plurality of continuous flooding locations from the flooding locations indicated by the flooding data acquired by the acquisition unit 112 (step S301).

The altitude acquisition unit 114 selects a reference flooding location from the plurality of continuous flooding locations extracted by the extraction unit 113, and acquires an altitude indicated by the terrain information associated with the selected reference flooding location in the terrain information database as an altitude of the extracted flooding location (step S302).

The water surface altitude estimating unit 115 calculates a sum of the respective water depth candidates of the plurality of flooding locations extracted by the extraction unit 113 and the respective altitudes acquired by the altitude acquisition unit 114, and estimates the sum as a water surface altitude at each of the plurality of extracted flooding locations (step S303).

Next, the water depth calculation unit 116 calculates an average of the water surface altitudes at each of the plurality of flooding locations extracted by the extraction unit 113 (step S304). Then, the water depth calculation unit 116 calculates a value obtained by subtracting the altitude acquired by the altitude acquisition unit 114 from the average of the water surface altitudes at each of the plurality of extracted flooding locations as the water depth of the extracted flooding location (step S305).

Therefore, according to the road information providing device 2 in the present embodiment, even if the water depth candidate calculated in the vehicle V that travels at the reference flooding location is influenced by the waves or the water splashes at the flooding locations that are continuous with the reference flooding location, the water depth can be calculated with the influence of the waves or the water splashes at the flooding location being reduced, so that the accuracy of calculating the water depth at the reference flooding location can be improved.

A road surface water depth calculation device according to an aspect of this disclosure includes, as an example, an acquisition unit configured to acquire flooding locations at which a vehicle travels and water depth candidates of the flooding locations; an extraction unit configured to extract a plurality of continuous flooding locations from the acquired flooding locations; an altitude acquisition unit configured to acquire altitudes of the extracted flooding locations; an estimation unit configured to calculate a sum of the water depth candidate and the altitude, acquired by the altitude acquisition unit, of each of the extracted flooding locations, and estimate the sum as a water surface altitude which is an altitude of a water surface of each of the extracted flooding locations; and a calculation unit configured to calculate a water depth of the extracted flooding location based on the water surface altitude and the altitude, acquired by the altitude acquisition unit, of each of the extracted flooding locations. Therefore, as an example, accuracy of calculating the water depth at the flooding location can be improved.

In the road surface water depth calculation device, as an example, the calculation unit may be configured to calculate, as the water depth of the flooding location, a value which is obtained by subtracting the altitude acquired by the altitude acquisition unit from an average of the plurality of the water surface altitudes, a mode value among the plurality of the water surface altitudes, or a median value of the plurality of water surface altitudes. Therefore, as an example, accuracy of calculating the water depth at the flooding location can be improved.

In the road surface water depth calculation device, as an example, the calculation unit may further calculate a maximum water depth among a flooding region including the extracted respective flooding locations and a flooding location thereof, based on a calculation result of the water depth of the flooding location and terrain of the flooding location. Therefore, as a result, accuracy of calculating the maximum water depth at the flooding location can be improved.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A road surface water depth calculation device, comprising:
an acquisition unit configured to acquire flooding locations at which a vehicle travels and water depth candidates of the flooding locations;
an extraction unit configured to extract a plurality of continuous flooding locations from the acquired flooding locations;
an altitude acquisition unit configured to acquire altitudes of the extracted flooding locations;
an estimation unit configured to calculate a sum of the water depth candidate and the altitude, acquired by the altitude acquisition unit, of each of the extracted flooding locations, and estimate the sum as a water surface altitude which is an altitude of a water surface of each of the extracted flooding locations; and
a calculation unit configured to calculate a water depth of the extracted flooding location based on the water surface altitude and the altitude, acquired by the altitude acquisition unit, of each of the extracted flooding locations.

2. The road surface water depth calculation device according to claim 1, wherein
the calculation unit is configured to calculate, as the water depth of the flooding location, a value which is obtained by subtracting the altitude acquired by the altitude acquisition unit from an average of the plurality of the water surface altitudes, a mode value among the plurality of the water surface altitudes, or a median value of the plurality of water surface altitudes.

3. The road surface water depth calculation device according to claim 1, wherein
the calculation unit further calculates a maximum water depth among a flooding region including the extracted respective flooding locations and a flooding location thereof, based on a calculation result of the water depth of the flooding location and terrain of the flooding location.
